(19) United States
(12) Patent Application Publication
(10) Pub. No.: US 2026/0019019 A1
(43) Pub. Date: Jan. 15, 2026

(54) MOTOR CONTROL DEVICE

(71) Applicant: FANUC CORPORATION, Minamitsuru-gun, Yamanashi (JP)

(72) Inventors: Takaki SHIMODA, Yamanashi (JP); Satoshi IKAI, Yamanashi (JP)

(73) Assignee: FANUC CORPORATION, Minamitsuru-gun, Yamanashi (JP)

(21) Appl. No.: 18/995,599

(22) PCT Filed: Aug. 25, 2022
(86) PCT No.: PCT/JP2022/032017

§ 371 Date: Jan. 16, 2025

(51) Int. Cl. H02P 23/20; H02P 23/14

(52) U.S. Cl. CPC H02P 23/20; H02P 23/14; H02P 2207/01

(57) ABSTRACT

Provided is technology that, in orientation control of an induction motor, makes it possible to detect correct acceleration/deceleration and stop a rotation shaft at a specific target position in a shorter time. The present invention is a motor control device that controls an induction motor for driving a rotation shaft and that performs orientation control to stop the rotating rotation shaft at a target position, said motor control device comprising: a speed comparison unit that calculates the difference between the actual speed of the rotation shaft and a speed command; a speed command calculation unit that, when the absolute value of the difference is less than a predetermined threshold value, changes the speed command so that the absolute value of the difference becomes greater than or equal to the threshold value; an acceleration command calculation unit that calculates an acceleration command during the orientation control on the basis of acceleration/deceleration which is calculated from the actual speed of the rotation shaft when the speed command has been changed; and a trajectory calculation unit that, on the basis of the acceleration command, calculates the speed command and/or a position command until the target position is reached.

### TECHNICAL FIELD

The present disclosure relates to a motor control device.

### BACKGROUND ART

Conventionally, motor control devices control the rotation amount, speed, torque, and the like of a servo motor that drives a rotary axis of an industrial machine such as a machine tool. As a control method by a motor control device, for example, orientation control has been known in which a spindle of a rotating industrial machine is stopped at a specific position for the purpose of tool replacement or the like (for example, see Patent Document 1).

In particular, orientation control which detects the maximum acceleration/deceleration when the applicable maximum electrical current at the present moment in time is applied to the servo motor for which the spindle is rotating to accelerate and decelerate the servo motor, and causes the spindle stop at a specific position by the acceleration command based on the detected maximum acceleration/deceleration is called the optimal orientation control. According to the optimal orientation control, the spindle can be stopped at a specific position in the shortest time.

### CITATION LIST

### Patent Document

Patent Document 1: Japanese Unexamined Patent Application, Publication No. 2021-27684

### DISCLOSURE OF THE INVENTION

### Problems to be Solved by the Invention

In the optimal orientation control, an orientation speed different from the current speed is set in order to detect the maximum acceleration/deceleration, and speed control for switching from the current speed to the orientation speed is executed. However, the induction motor used as a servo motor has a characteristic in that it takes time for the magnetic flux to sufficiently rise during acceleration and deceleration. Therefore, when the difference between the orientation speed and the current speed is small, the detection time of the acceleration/deceleration is not sufficient. Due to this, a small acceleration/deceleration in a state where the magnetic flux does not sufficiently rise, that is, a sufficient torque is not obtained, will be erroneously recognized as the maximum acceleration/deceleration, and the correct maximum acceleration/deceleration cannot be detected. Therefore, the orientation control based on the acceleration command based on the acceleration/deceleration smaller than the maximum acceleration/deceleration is executed. Therefore, there is a problem in that the orientation time becomes long.

An object of the present disclosure is to provide a technique capable of detecting the correct acceleration/deceleration and stopping a rotary axis at a specific target position in a shorter time in the orientation control of an induction motor.

### Means for Solving the Problems

The present disclosure is directed to a motor control device that controls an induction motor for driving a rotary axis, and executes orientation control for stopping the rotary axis which is rotating at a target position, the motor control device including: a speed comparator that calculates a difference between an actual speed of the rotary axis and a speed command; a speed command calculator that, in a case in which an absolute value of the difference is smaller than a predetermined threshold, changes the speed command so that the absolute value of the difference is equal to or larger than the threshold; an acceleration command calculator that calculates an acceleration command for a time of the orientation control based on an acceleration/deceleration calculated from the actual speed of the rotary axis when the speed command is changed; and a path calculator that calculates, based on the acceleration command, at least one command of a position command or a speed command until the target position is reached.

### Effects of the Invention

According to the present disclosure, it is possible to provide a technology capable of detecting the correct acceleration/deceleration and stopping the rotary axis at a specific target position in a shorter time in the orientation control of the induction motor.

### BRIEF DESCRIPTION OF THE DRAWINGS

FIG. 1 is a block diagram showing a configuration of a control device according to an embodiment of the present disclosure;

FIG. 2 provides graphs showing a primary-side d-axis current, a secondary-side d-axis interlinkage magnetic flux, a primary-side q-axis current, and a torque T of the induction motor;

FIG. 3 is a graph showing changes in speed from time t₀ to time t₃ and from time t₃ to time t₁ in FIG. 2;

FIG. 4 is a graph showing magnitudes of acceleration/deceleration maximum values detected at time t₀ to time t₃ and time t₀ to time t₁ in FIG. 2;

FIG. 5 is a flowchart showing a procedure of speed control processing in orientation control according to an embodiment of the present disclosure;

FIG. 6 is a flowchart showing a procedure of acceleration calculation processing;

FIG. 7 is a flowchart showing a procedure of positioning control processing in orientation control according to an embodiment of the present disclosure;

FIG. 8 is a diagram for describing position command (path) calculation processing according to an embodiment of the present disclosure;

FIG. 9 is a diagram for describing positioning control according to an embodiment of the present disclosure;

FIG. 10 is a flowchart showing a procedure of position command (path) calculation processing;

FIG. 11 is a diagram showing conventional orientation control, and is a diagram showing a speed change when stopping at a target position by decelerating after accelerating;

FIG. 12 is a diagram showing orientation control according to an embodiment of the present disclosure, and is a diagram showing a speed change when stopping at a target position by decelerating after accelerating;

FIG. 13 is a diagram showing conventional orientation control, and is a diagram showing a speed change when stopping at a target position only by deceleration;

FIG. 14 is a diagram showing orientation control according to an embodiment of the present disclosure, and is a diagram showing a speed change when stopping at a target position only by deceleration; and

FIG. 15 is a block diagram showing a configuration of a control device according to a modification of an embodiment of the present disclosure.

### PREFERRED MODE FOR CARRYING OUT THE INVENTION

Hereinafter, an embodiment of the present disclosure will be described in detail with reference to the drawings.

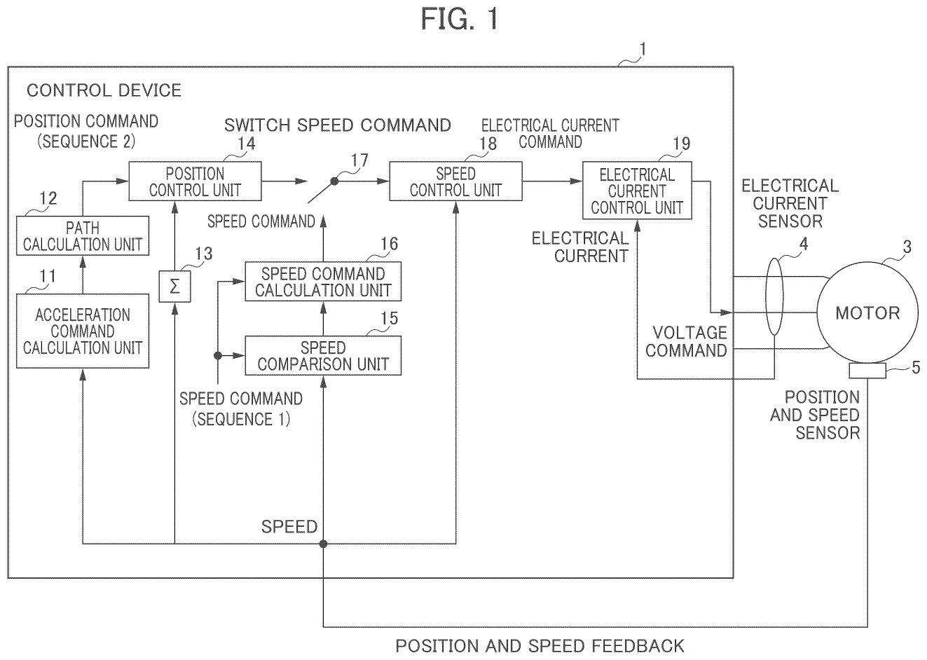

FIG. 1 is a block diagram showing a configuration of a control device 1 according to an embodiment of the present disclosure. The control device 1 according to the present embodiment is a control device of a motor 3 that drives a rotary axis of a machine tool or an industrial machine such as a robot. As illustrated in FIG. 1, the control device 1 includes an acceleration command calculation unit 11, a path calculation unit 12, an integrator 13, a position control unit 14, a speed comparison unit 15, a speed command calculation unit 16, a switching unit 17, a speed control unit 18, and a current control unit 19.

The control device 1 executes orientation control for stopping the rotating rotary axis at a specific target position by the above-described respective functional units. In particular, in order to secure a sufficient acceleration/deceleration detection time when the current speed (initial speed) and the orientation speed are close to each other and the difference therebetween is small in the orientation control, the control device 1 can detect a correct acceleration/deceleration by changing the orientation speed, and can stop the spindle or the like of the machine tool at a specific target position in a shorter time.

The control device 1 is configured using a computer including memory such as ROM (read only memory) and RAM (random access memory), a CPU (control processing unit), a communication control unit, and the like, which are mutually connected via a bus, for example. The functions and operations of the functional units are achieved by cooperation of a CPU and memory, which are built into the computer, and the control programs stored in the memory.

The control device 1 is connected to CNC (Computer Numerical Controller), which is not shown. Signals such as a speed command, a position command, and an orientation command are inputted from the CNC to the control device 1.

Further, as shown in FIG. 1, in order to drive and control the motor 3, a current sensor 4 that detects a current value applied to the motor 3 in response to a voltage command applied to the motor 3 is electrically connected to the control device 1. Further, a position and speed sensor 5 for detecting the position and speed of the motor 3 is electrically connected to the control device 1.

The motor 3 drives a rotary axis of an industrial machine such as a machine tool or a robot. The motor 3 of the present embodiment is a servo motor constituted by an induction motor. In the induction motor, an induced current is generated in a rotor by a rotating magnetic field generated by a stator, and a rotational torque corresponding to slippage is generated.

The current sensor 4 detects a current flowing through the motor 3 in response to a voltage command applied to the motor 3. The current value detected by the current sensor 4 is transmitted to the current control unit 19.

The position and speed sensor 5 is provided in the motor 3 and detects the position and speed of the motor 3. The position and speed values of the motor 3 detected by the position and speed sensor 5 are transmitted to the acceleration command calculation unit 11, the integrator 13, the speed comparison unit 15, and the speed control unit 18, respectively. As a specific position and speed sensor 5, for example, an encoder is used.

The acceleration command calculation unit 11 calculates an acceleration command at the time of the orientation control based on an acceleration/deceleration calculated from an actual speed of the rotary axis when the speed command is changed by the speed command calculation unit 16 described later. That is, in order to secure a sufficient acceleration/deceleration detection time when the current speed (initial speed) and the orientation speed are close to each other in the orientation control, the acceleration calculation unit 11 calculates the acceleration/deceleration from the actual speed when the orientation speed was changed, and calculates the acceleration command based on the calculated acceleration/deceleration. The actual speed of the rotary axis is acquired from the position and speed detection value transmitted from the position and speed sensor 5.

In addition, it is preferable that, at the time of speed control until the actual speed is switched from the current speed (initial speed) to the orientation speed changed in the above-described case, the acceleration command calculation unit 11 calculates the acceleration/deceleration when the applicable maximum current at that time is applied to the motor 3 to accelerate and decelerate the motor 3 in a predetermined cycle. This makes it possible to calculate the acceleration command based on the correct maximum acceleration/deceleration.

Specifically, the acceleration command calculation unit 11 preferably sets a value of the maximum acceleration/deceleration having the largest magnitude among the calculated accelerations/decelerations as the absolute value of the acceleration command. However, not only for the optimal orientation control, but also in applications to broader orientation control, the acceleration command may be calculated based on an average value or an instantaneous value, rather than being limited to the maximum value of the calculated acceleration/deceleration.

The acceleration command calculation unit 11 calculates acceleration/deceleration for each orientation control. The orientation control is executed, for example, when a tool of a machine tool is replaced. Since the inertia of the spindle changes due to the replacement of the tool, it is important to detect the acceleration/deceleration.

The path calculation unit 12 calculates a position command until a specific target stop position is reached based on the acceleration command of the orientation control. The acceleration command is acquired from the abovementioned acceleration command calculation unit 11.

It is preferable that the path calculation unit 12 calculates a position command for performing acceleration/deceleration at the maximum acceleration/deceleration so as to minimize the time until the target stop position is reached. Specifically, it is preferable to calculate the position command for accelerating at the maximum acceleration, and then decelerating at the maximum deceleration to stop at the target position.

The integrator 13 acquires the actual position by integrating the actual speed of the rotary axis. The acquired actual position is transmitted to the position control unit 14. The actual speed is acquired from the position and speed detection value transmitted from the position and speed sensor 5.

The position control unit 14 calculates the speed command based on the positional deviation between the actual position and the position command from the integrator 13. The calculated speed command is transmitted to the switching unit 17.

The speed comparison unit 15 calculates a difference between the actual speed of the rotary axis and the speed command. The difference obtained by the calculation is transmitted to the speed command calculation unit 16. The actual speed is acquired from the position and speed detection value transmitted from the position and speed sensor 5. The speed command is inputted from the CNC.

When the absolute value of the difference is smaller than a predetermined threshold, the speed command calculation unit 16 changes the speed command so that the absolute value of the difference becomes equal to or larger than the threshold. The changed speed command is transmitted to the switching unit 17.

The threshold is preferably set for each motor 3. Specifically, the threshold is preferably set based on a magnetic flux rise time according to the resistance and inductance of the induction motor. It may be calculated and set based on the current speed.

Specifically, when the absolute value of the difference between the actual speed vₛₜ and the speed command v₁ is smaller than the threshold vₜₕ where the actual speed (current speed) is vₛₜ, the speed command is v₁, and the threshold is vₜₕ, the speed command calculation unit 16 preferably changes the speed command v₁ to the speed command v₂₁ represented by the following Expression (1) or the speed command v₂₂ represented by the following Expression (2).

$$\begin{matrix}[ Expression 1 ] & \\ {v}_{21} = {v}_{st} - {v}_{th} & EXPRESSION ( 1 )\end{matrix}$$

$${v}_{22} = {v}_{st} + {v}_{th} \qquad EXPRESSION ( 2 )$$

The switching unit 17 switches between the speed command from the position control unit 14 and the speed command from the speed command calculation unit 16. That is, the switching unit 17 performs switching between the speed control (sequence 1) and the positioning control (sequence 2) in the orientation control of the present embodiment.

The speed control unit 18 calculates an electrical current command based on the speed command from the switching unit 17. The calculated and acquired electrical current command is transmitted to the current control unit 19.

The current control unit 19 calculates a voltage command to be applied to the motor 3 based on the electrical current command, and applies an electrical current corresponding to the calculated voltage command to the motor 3. The current control unit 19 acquires the electrical current value detected by the current sensor 4, and performs electrical current feedback control so that the difference between the acquired electrical current value and the command value becomes 0.

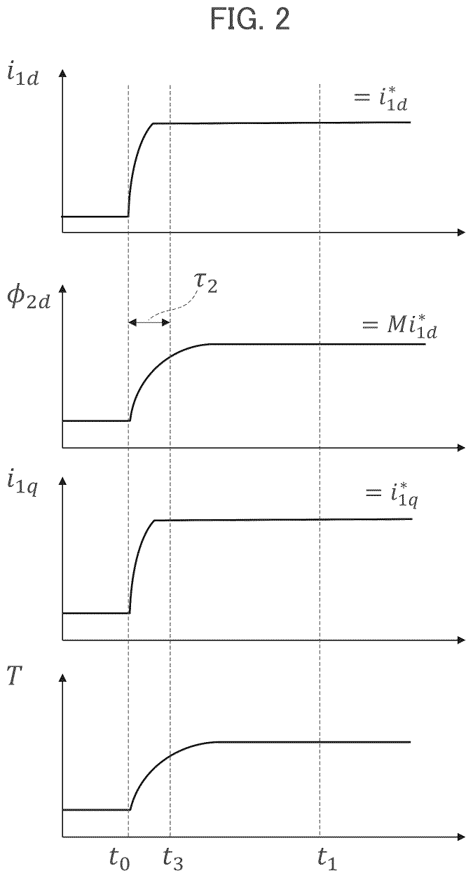

Next, the characteristics of the induction motor constituting the motor 3 will be described in detail with reference to FIGS. 2 to 4.

First, slip frequency vector control is applied to the motor 3 constituted by an induction motor. In the slip frequency vector control, a sum of a slip frequency, which is a frequency of an electrical current flowing through a rotor winding of an induction motor, and a motor rotation frequency is controlled as an output frequency of an inverter. At this time, the torque T of the motor 3 is expressed by the following Expression (3).

$$\begin{matrix}[ Expression 2 ] & \\ T = \frac{{P}_{n} M}{{L}_{2}} {ϕ}_{2 d} {i}_{1 q} & EXPRESSION ( 3 )\end{matrix}$$

In Expression (3), Pₙ is the number of pole pairs, M is the mutual inductance, L₂ is the secondary-side inductance, φ_{2d} is the secondary-side d-axis interlinkage magnetic flux, and i_{1q} is the primary-side q-axis current.

The secondary-side d-axis interlinkage magnetic flux φ_{2d} rises at a time constant τ₂ represented by the following Expression (5) from the relational expression of the following Expression (4).

$$\begin{matrix}[ Expression 3 ] & \\ \frac{d {ϕ}_{2 d}}{dt} = \frac{{R}_{2} M}{{L}_{2}} {i}_{1 d} - \frac{{R}_{2}}{{L}_{2}} {ϕ}_{2 d} & EXPRESSION ( 4 )\end{matrix}$$

In Expression (4), R₂ is a secondary-side resistance, and i_{1d} is a primary-side d-axis electrical current.

$$\begin{matrix}[ Expression 4 ] & \\ {τ}_{2} = \frac{{L}_{2}}{{R}_{2}} & EXPRESSION ( 5 )\end{matrix}$$

Here, FIG. 2 is a diagram showing the primary-side d-axis current i_{1d}, the secondary-side d-axis interlinkage magnetic flux φ_{2d}, the primary-side q-axis current i_{1q}, and the torque T of the motor 3 constituted by an induction motor. Specifically, FIG. 2 is a diagram showing a temporal change of each of these parameters at the time of rising. As shown in FIG. 2, the primary side d-axis electrical current i_{1d} is a controllable electrical current contributing to the magnetic flux, and has risen from time t₀ and already reached the maximum value i*_{1d} at time t₃. Similarly, the primary-side q-axis electrical current i_{1q} is a controllable electrical current that contributes to the torque T as shown in the above Expression (3), and has risen from time to and already reached the maximum value i*_{1q} at time t₃.

On the other hand, the secondary-side d-axis interlinkage magnetic flux 92d rises from the time t₀ and has not yet reached the maximum value Mi*_{1d} at the time t₃, and it can be seen that the time constant τ₂ is long. Specifically, the time constant of the current control of the primary side d-axis electrical current i_{1d} and the primary side q-axis current i_{1q} is 1 ms or less; whereas, the time constant τ₂ of the secondary side d-axis interlinkage magnetic flux φ_{2d} is 1 ms to 500 ms. In addition, in the secondary-side d-axis interlinkage magnetic flux φ_{2d}, the time constant τ₂ is a value specific to the motor represented by the secondary-side inductance L₂ and the secondary-side resistance R₂ as expressed by the above-described Expression (5), and the rise time thereof cannot be controlled.

Therefore, as shown in FIG. 2, the torque T of the motor 3 expressed as the product of the secondary-side d-axis interlinkage magnetic flux φ_{2d} and the primary-side q-axis electrical current i_{1q} as expressed by the above Expression (3) has a long time constant and a slow rise, similarly to the secondary-side d-axis interlinkage magnetic flux φ_{2d}. That is, the motor 3 constituted by the induction motor takes time until the magnetic flux sufficiently rises at the time of acceleration and deceleration, and thus has a characteristic in that the rise of the torque is also slow.

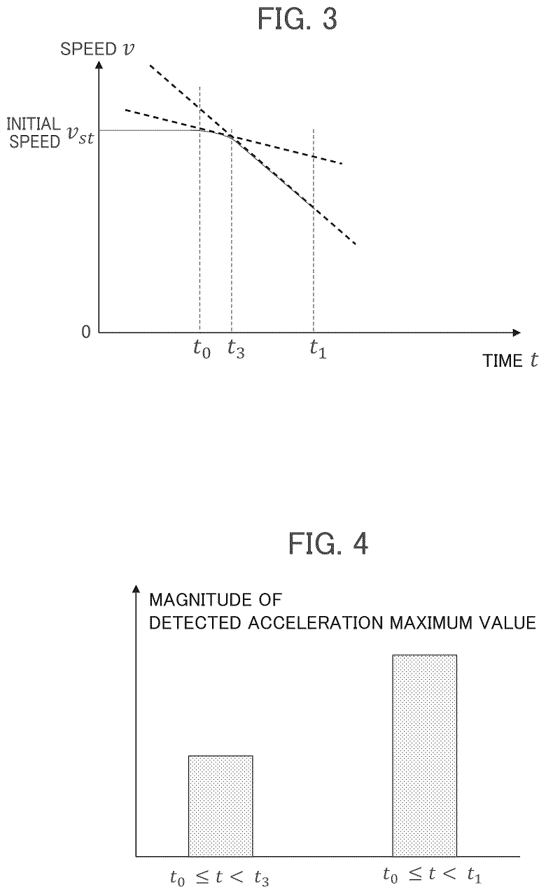

FIG. 3 is a diagram showing changes in speed from time t₀ to time t₃ and from time t₃ to time t₁ in FIG. 2. From time t₀ to time t₃, since the magnetic flux and the torque of the motor 3 are not sufficiently raised as described above, it can be seen that the gradient of the speed, that is, the deceleration from the initial speed vₛₜ, is small. On the other hand, in the period from the time t₃ to the time t₁, since the state in which the magnetic flux and the torque of the motor 3 sufficiently rise is included, it can be seen that the deceleration is larger than that in the period from the time t₀ to the time t₃.

FIG. 4 is a diagram showing the magnitude of the acceleration/deceleration maximum value detected from time t₀ to time t₃ and from time t₀ to time t₁ in FIG. 2. As is clear from FIG. 4, the acceleration/deceleration maximum value detected in the time t₀ to the time t₁ is larger than the acceleration/deceleration maximum value detected in the time t₀ to the time t₃.

Therefore, in order to detect the correct acceleration/deceleration or maximum acceleration/deceleration, it is important to set the orientation speed so as to ensure a sufficient difference between the initial speed and the orientation speed in order to ensure a sufficient acceleration/deceleration detection time during the orientation control. Therefore, in the present embodiment, when the current speed (initial speed) and the orientation speed are close to each other during speed control for switching from the current speed (initial speed) to the orientation speed, the orientation speed is changed so that the difference between the initial speed and the orientation speed becomes larger than the threshold. As a result, a sufficient acceleration/deceleration detection time is secured, and the correct acceleration/deceleration and maximum acceleration/deceleration can be detected.

Next, the procedure of the orientation control processing according to the present embodiment will be described in detail with reference to the drawings.

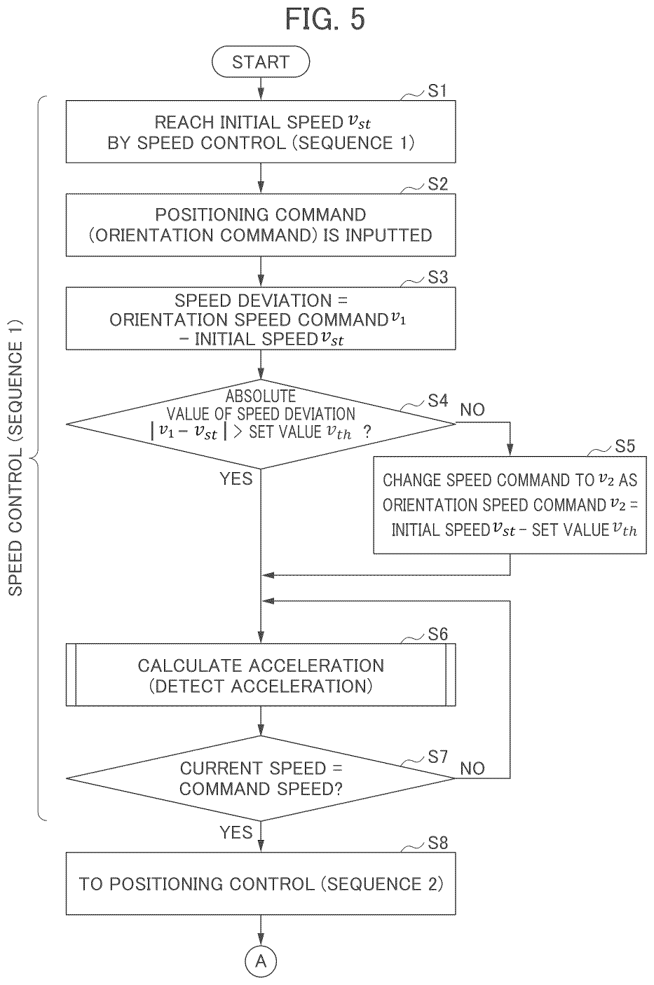

FIG. 5 is a flowchart showing a procedure of speed control processing in the orientation control according to the present embodiment. The orientation control according to the present embodiment is executed by the control device 1 when, for example, a tool of a machine tool is replaced. In the present embodiment, the speed control based on the speed command is referred to as sequence 1, and the positioning control based on the position command is referred to as sequence 2.

In Step S1, the speed control (sequence 1) is executed to cause the speed of the motor 3 to reach the initial speed vₛₜ. Thereafter, the processing proceeds to Step S2. Here, although the induction motor has a characteristic in that the torque cannot be sufficiently outputted at high speed even when the magnetic flux is sufficiently raised, the induction motor can output a sufficient torque at low speed, but it takes time to adjust the phase to reach the target position. Therefore, it is preferable that the initial speed vₛₜ is set to an appropriate medium speed so that the torque can be appropriately obtained and the time for phase adjustment for reaching the target position can be shortened.

In Step S2, the positioning command (orientation command) is inputted to the control device 1. This positioning command (orientation command) is transmitted from the above-described CNC. Thereafter, the processing proceeds to Step S3.

In Step S3, a speed deviation, which is a difference between the orientation speed command v₁ and the initial speed vₛₜ, is acquired. Thereafter, the processing proceeds to Step S4.

In Step S4, it is determined whether the absolute value |v₁−vₛₜ| of the speed deviation is larger than a set value (threshold) vₜₕ. If it is determined as YES, the processing proceeds to Step S6. If it is determined as NO, the processing proceeds to Step S5, and the orientation speed command v₁ is changed to the orientation speed command v₂, and then the processing proceeds to Step S6. The orientation speed command v₂ is set to, for example, a speed command obtained by subtracting a set value (threshold) vₜₕ from the initial speed vₛₜ, as shown in the above Expression (1).

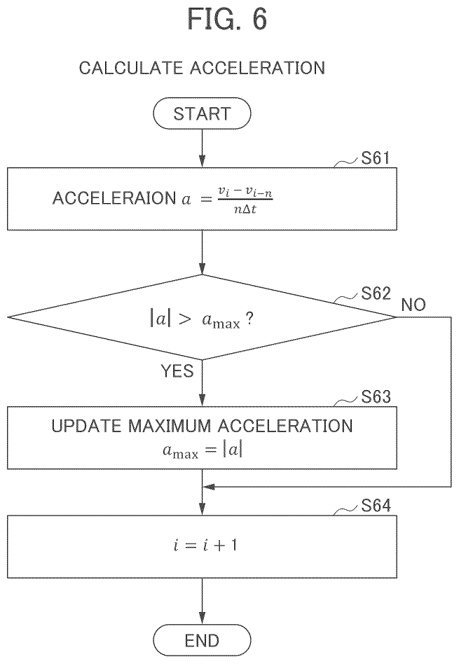

In Step S6, acceleration calculation (acceleration detection) processing is executed. Thereafter, the processing proceeds to Step S7. Details of the acceleration calculation (acceleration detection) processing will be described with reference to FIG. 6. FIG. 6 is a flowchart showing a procedure of acceleration calculation processing.

In Step S61, the acceleration a is calculated. Specifically, the acceleration a is calculated by the following Expression (6). Thereafter, the processing proceeds to Step S62.

$$\begin{matrix}[ Expression 5 ] & \\ a = \frac{{v}_{i} - {v}_{i - n}}{n Δ t} & EXPRESSION ( 6 )\end{matrix}$$

In Expression (6), Δt is a sampling period, vᵢ is an actual speed at time t=iΔt, vᵢ₋ₙ is an actual speed at time t=(i−n)Δt, n is a natural number, and i is a variable.

In Step S62, it is determined whether the absolute value |a| of the acceleration a calculated in Step S61 is larger than the maximum acceleration aₘₐₓ. If it is determined as YES, the processing proceeds to Step S63. If it is determined as NO, the processing proceeds to Step S64. The initial value of the maximum acceleration aₘₐₓ is set to 0.

In Step S63, the maximum acceleration aₘₐₓ is updated to the absolute value |a| of the acceleration a calculated in Step S61. Thereafter, the processing proceeds to Step S64.

In Step S64, 1 is added to the variable i to set i=i+1, and the present processing is ended.

The acceleration calculation (acceleration detection) processing described above is an example in which the maximum acceleration aₘₐₓ is set as the calculated (detected) acceleration. This acceleration calculation (acceleration detection) processing is repeatedly executed until the current speed corresponds to the orientation command speed, as described later in Step S7.

Returning to FIG. 5, in Step S7, it is determined whether the current speed corresponds to the orientation command speed. If it is determined as YES, the processing proceeds to Step S8. If it is determined as NO, the processing returns to Step S6 to repeatedly execute the acceleration calculation (acceleration detection) processing.

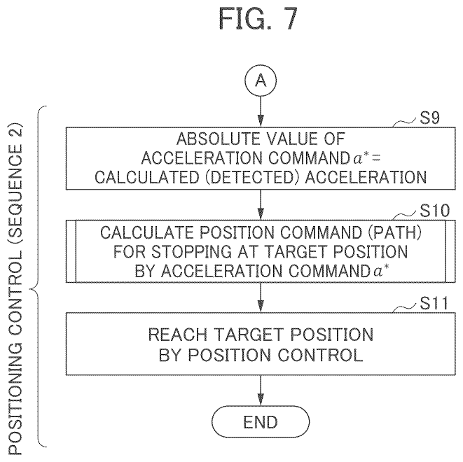

In Step S8, the processing proceeds to the positioning control (sequence 2), and the positioning control (sequence 2) is executed. Thereafter, the processing proceeds to Step S9 in FIG. 7. FIG. 7 is a flowchart showing a procedure of positioning control processing in the orientation control according to the present embodiment.

In Step S9, the absolute value of the acceleration command a* is set to the calculated (detected) acceleration. Thereafter, the processing proceeds to Step S10.

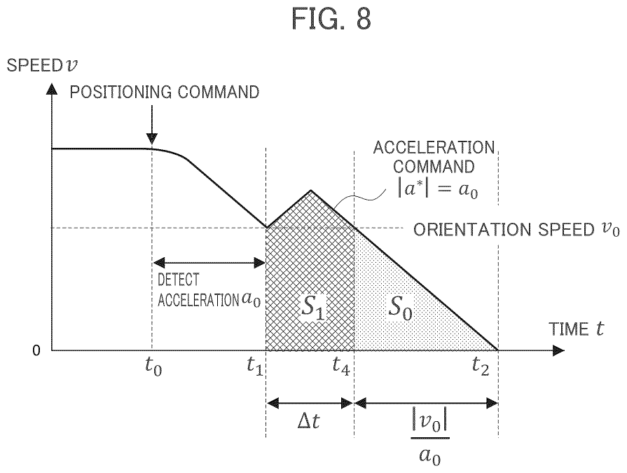

In Step S10, a position command (path) to stop at the target position is calculated based on the acceleration command a*. Thereafter, the processing proceeds to Step S11. Details of the position command (path) calculation processing will be described with reference to FIGS. 8 to 10.

FIG. 8 is a diagram for explaining a position command (path) calculation processing according to the present embodiment. Specifically, FIG. 8 is a diagram showing a speed change in the orientation control according to the present embodiment. As shown in FIG. 8, when a positioning command (orientation command) is inputted to the control device 1 at time t₀, the acceleration a₀ (maximum detected acceleration in the example of the present embodiment) is detected by executing acceleration calculation (detection) processing between time t₀ and time t₁ from the current speed (initial speed) to the orientation speed v₀.

At this time, the acceleration command is calculated so that the absolute value |a*| of the acceleration command becomes the calculated (detected) acceleration a₀. Based on the calculated acceleration command and the position (phase angle) of the rotary axis at the positioning control start time t₁ with respect to the target stop position of the rotary axis, a distance S₁ for which the rotary axis is accelerated at the maximum from the start of the positioning control, and then decelerated at the maximum until the rotary axis returns to the orientation speed v₀, and a remaining distance S₀ for which the rotary axis is decelerated at the maximum until the target stop position are determined. The reason why the acceleration command for performing the maximum acceleration and then the maximum deceleration after the start of the positioning control is set is to stop the rotary axis at the target position in the shortest time. However, depending on the position (phase angle) of the rotary axis at the positioning control start time t₁ with respect to the target stop position of the rotary axis, there are cases where the acceleration command may be a command for performing the maximum deceleration solely.

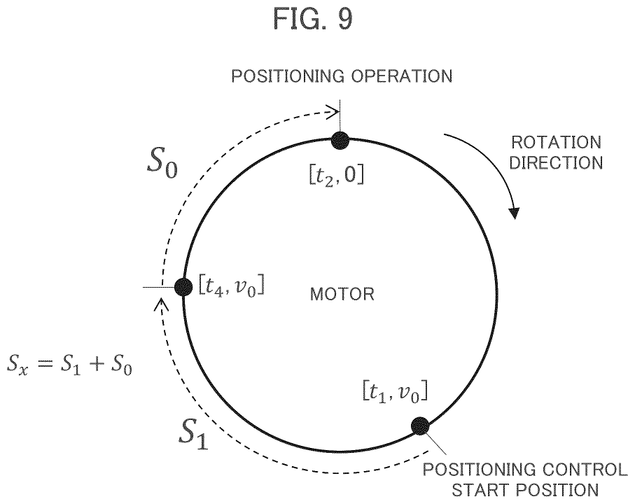

FIG. 9 is a diagram for explaining positioning control according to the present embodiment. Specifically, FIG. 9 shows a movement distance Sₓ in the rotation direction in the positioning control of the rotary axis. As shown in FIG. 9, the movement distance Sₓ is the sum of the distance S₁ for which the rotary axis is accelerated at the maximum from the start of the positioning control and then decelerated at the maximum until the rotary axis returns to the orientation speed v₀, and the remaining distance S₀ for which the rotary axis is decelerated at the maximum until the target stop position.

As understood from FIG. 8, when the time t₄-t₁ during which the rotary axis is accelerated at the maximum from the start of the positioning control, and then decelerated at the maximum until the rotary axis returns to the orientation speed v₀, is defined as Δt, the distance S₁ is represented by the following Expression (7). Further, since the time t₂-t₄ during which the rotary axis is decelerated at the maximum until the target stop position is expressed by |v₀|/a₀, the distance S₀ is represented by the following Expression (8).

$$\begin{matrix}[ Expression 6 ] & \\ {S}_{1} = \vert {v}_{0} \vert Δ t + \frac{1}{4} {a}_{0} Δ {t}^{2} & EXPRESSION ( 7 )\end{matrix}$$

$$\begin{matrix}[ Expression 7 ] & \\ {S}_{0} = \frac{{v}_{0}^{2}}{2 {a}_{0}} & EXPRESSION ( 8 )\end{matrix}$$

Therefore, the movement distance Sₓ is expressed by the following Expression (9) using the above Expressions (7) and (8).

$$\begin{matrix}[ Expression 8 ] & \\ {S}_{x} = \vert {v}_{0} \vert Δ t + \frac{1}{4} {a}_{0} Δ {t}^{2} + \frac{{v}_{0}^{2}}{2 {a}_{0}} & EXPRESSION ( 9 )\end{matrix}$$

From the above Expression (9), the time Δt during which the rotary axis is accelerated at the maximum from the start of the positioning control, and then decelerated at the maximum until the rotary axis returns to the orientation speed v₀ is expressed by the following Expression (10).

$$\begin{matrix}[ Expression 9 ] & \\ Δ t = \frac{2}{{a}_{0}} ( - \vert {v}_{0} \vert + \sqrt{\frac{1}{2} {v}_{0}^{2} + {a}_{0} {S}_{x}} ) & EXPRESSION ( 10 )\end{matrix}$$

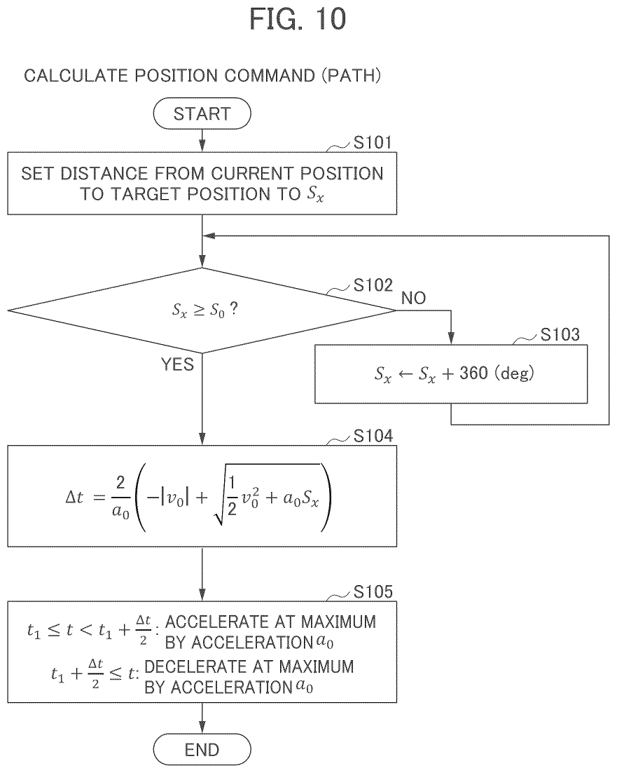

Based on the above, the procedure of the position command (path) calculation processing will be described. Here, FIG. 10 is a flowchart showing a procedure of a position command (path) calculation processing.

In Step S101, the distance from the current position (positioning control start position at time t₁ in FIG. 8) to the target stop position is defined as Sₓ. Thereafter, the processing proceeds to Step S102.

In Step S102, it is determined whether the distance Sₓ is equal to or greater than the remaining distance S₀ for which the rotary axis is decelerated at the maximum until the target stop position. As described above, the distance S₀ is expressed by the above Expression (8). If it is determined as YES, the processing proceeds to Step S104. If it is determined as NO, the processing proceeds to Step S103.

In Step S103, 360 (deg) is added to the distance Sₓ from the current position (positioning control start position at time t₁ in FIG. 8) to the target stop position. This is because, if the determination in Step S102 is NO, that is, if the distance Sₓ is smaller than the remaining distance S₀ for which the rotary axis is decelerated at the maximum until the target stop position, since it is not possible to stop the rotary axis at the target position with the maximum deceleration, it is necessary to add the movement distance for one rotation so that the distance S₁ for which the rotary axis is accelerated at the maximum from the start of the positioning control and then decelerated at the maximum until the rotary axis returns to the orientation speed v₀ is secured. Thereafter, the processing returns to Step S102 to again check whether the distance Sₓ is equal to or greater than the distance S₀, and the processing proceeds to Step S104.

In Step S104, a time Δt during which the rotary axis is accelerated at the maximum from the start of the positioning control, and then decelerated at the maximum until the rotary axis returns to the orientation speed v₀ is calculated. Specifically, it is calculated according to the above Expression (10). Thereafter, the processing proceeds to Step S105.

In Step S105, an acceleration command for accelerating the rotary axis with the maximum acceleration is calculated if the time t is between time t₁ and time t₁+Δt/2. Further, if the time t exceeds the time t₁+Δt/2, the acceleration command for decelerating the rotary axis at the maximum deceleration is calculated. As a result, it is possible to perform the maximum acceleration in the former half of the time Δt during which the rotary axis is accelerated at the maximum from the start of the positioning control, and then decelerated at the maximum until the rotary axis returns to the orientation speed v₀, and perform the maximum deceleration in the latter half thereof. Thereafter, the present processing is ended.

Returning to FIG. 7, in Step S11, the rotary axis is made to reach and stop at the target position by the position control. The orientation control processing according to the present embodiment is thereby ended.

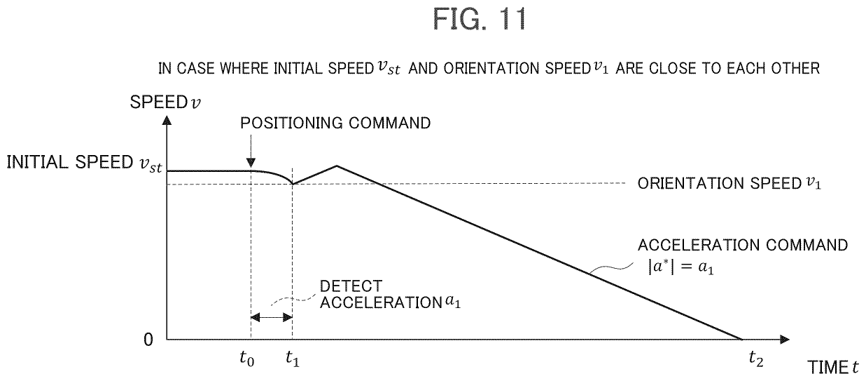

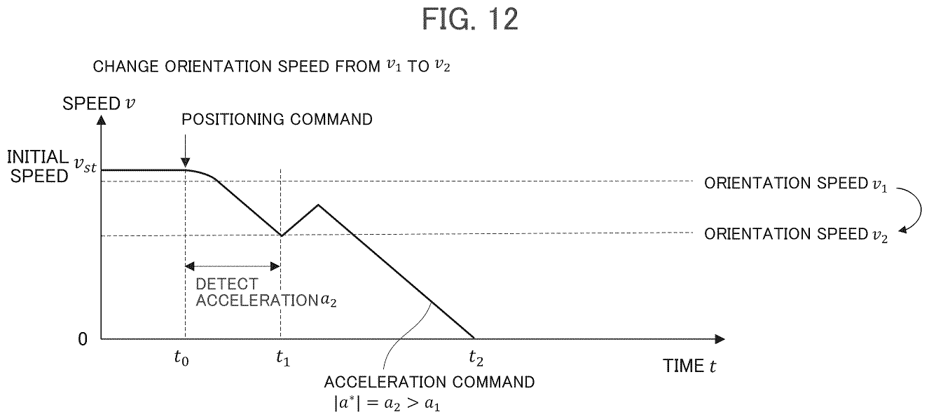

Next, a specific example of the orientation control according to the present embodiment will be described with reference to FIGS. 11 to 14 in comparison with the conventional orientation control.

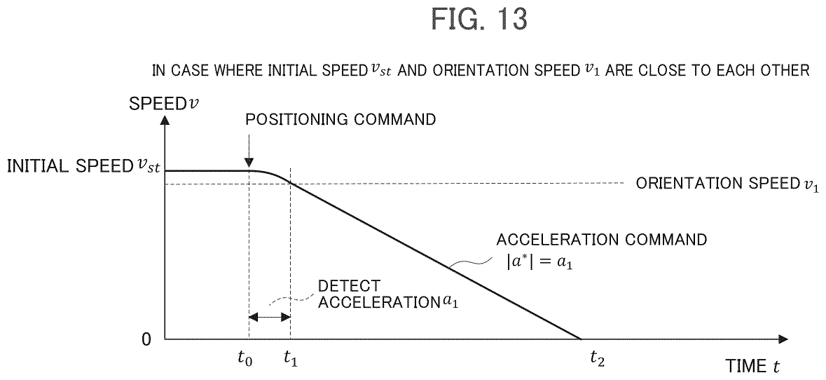

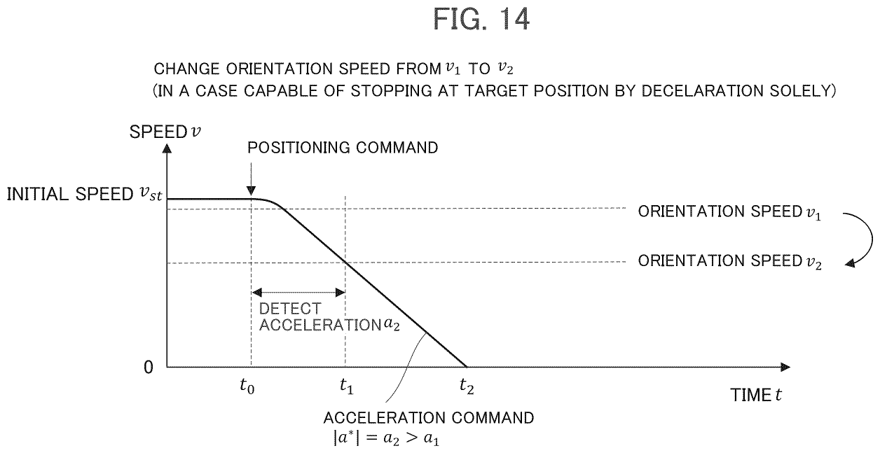

FIG. 11 is a diagram showing conventional orientation control, and is a diagram showing a speed change when stopping at a target position by maximum deceleration after maximum acceleration. FIG. 12 is a diagram showing the orientation control according to the present embodiment, and is a diagram showing a speed change when stopping at a target position by maximum deceleration after maximum acceleration. In addition, FIG. 13 is a diagram showing the conventional orientation control, and is a diagram showing a speed change when stopping at the target position only by the maximum deceleration. FIG. 14 is a diagram showing the orientation control according to the present embodiment, and is a diagram showing a speed change when stopping at the target position only by maximum deceleration. In any of FIGS. 11 to 14, the speed control (sequence 1) is executed from time t₀ to time t₁, and the positioning control (sequence 2) is executed from time t₁ to time t₂.

As shown in FIGS. 11 and 13, in the conventional orientation control, when the difference between the orientation speed v₁ and the current speed (initial speed vₛₜ) is small, since the detection time t₁-t₀ of the acceleration/deceleration is short, the small acceleration/deceleration a₁ in a state where the magnetic flux of the motor 3 does not sufficiently rise, that is, a sufficient torque is not obtained, is erroneously recognized as the maximum acceleration/deceleration, and the correct maximum acceleration/deceleration cannot be detected. Therefore, it can be seen that the positioning control according to the acceleration command based on the acceleration/deceleration a₁ smaller than the maximum acceleration/deceleration is executed, and the time t₂ when the target stop position is reached is delayed.

On the other hand, as shown in FIG. 12 and FIG. 14, in the orientation control of the present embodiment, when the difference between the orientation speed v₁ and the current speed (initial speed vₛₜ) is smaller than a predetermined threshold vₜₕ, the orientation speed v₂ which has a difference from the current speed (initial speed vₛₜ) equal to or larger than the predetermined threshold vₜₕ is adopted. As a result, the detection time t₁-t₀ of the acceleration/deceleration is ensured to be longer than that in the related art, and the correct maximum acceleration/deceleration a₂ in a state in which the magnetic flux of the motor 3 sufficiently rises to obtain a sufficient torque is detected. Therefore, it can be seen that the positioning control according to the acceleration command based on the correct maximum acceleration/deceleration a₂ is executed, and the time t₂ when reaching the target stop position becomes earlier.

According to the present embodiment, the following advantageous effects are achieved.

The present embodiment provides the speed comparison unit 15 that calculates the difference between the actual speed of the rotary axis and the speed command, and the speed command calculation unit 16 that, when the absolute value of the difference is smaller than a predetermined threshold, changes the speed command so that the absolute value of the difference becomes equal to or larger than the threshold. Further, the acceleration command calculation unit 11 that calculates an acceleration command at the time of the orientation control based on the acceleration/deceleration calculated from the actual speed of the rotary axis when the speed command was changed, and the path calculation unit 12 that calculates a position command until the target position is reached based on the acceleration command are provided.

With such a configuration, in a case where the current speed (initial speed) and the orientation speed are close to each other and the difference therebetween is small in the orientation control, it is possible to detect the correct acceleration/deceleration by changing the orientation speed in order to secure a sufficient acceleration/deceleration detection time. Therefore, it is possible to stop the spindle or the like of the machine tool at a specific target position in a shorter time.

Further, it is configured in the present embodiment to calculate the acceleration/deceleration when the applicable maximum electrical current is applied to the motor 3 to accelerate and decelerate the motor 3, to set the value of the maximum acceleration/deceleration having the maximum magnitude among the calculated accelerations/decelerations as the absolute value of the acceleration command, and to calculate the position command for performing acceleration/deceleration at the maximum acceleration/deceleration so as to minimize a time until the target position is reached.

With such a configuration, since it is possible to execute the positioning control to the target stop position by the acceleration command based on the correct maximum acceleration/deceleration, it is possible to stop the spindle or the like of the machine tool at a specific target position in a shorter time.

Further, it is configured in the present embodiment to calculate a position command for accelerating with the maximum acceleration, and then decelerating with the maximum deceleration to stop at the target position.

With such a configuration, since it is possible to execute the positioning control to the target stop position after accelerating at the correct maximum acceleration according to the acceleration command based on the correct maximum acceleration/deceleration, it is possible to stop the spindle or the like of the machine tool at a specific target position in the shortest time.

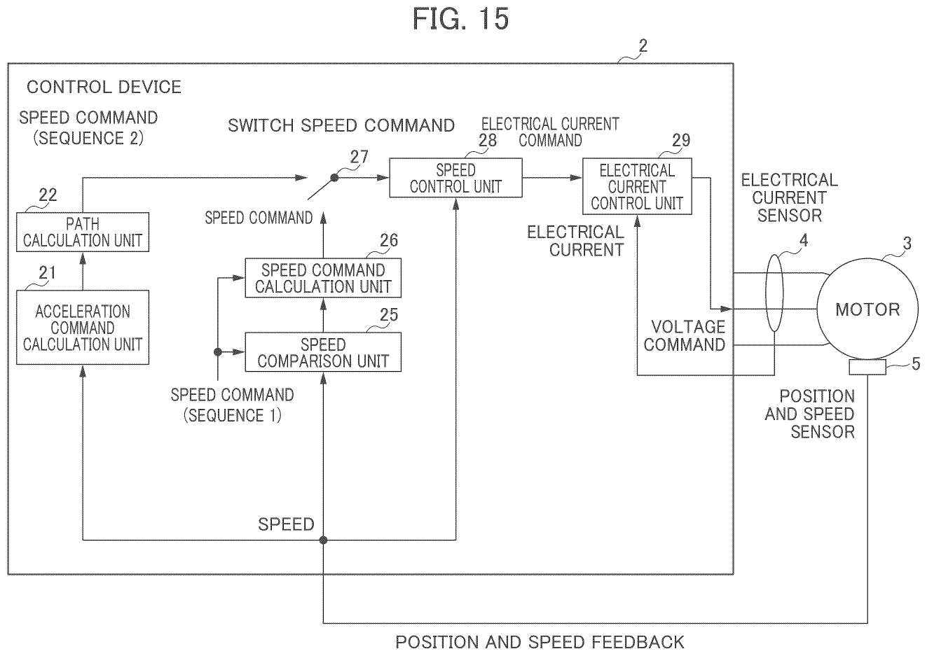

Next, a modification of the above embodiment will be described with reference to FIG. 15.

FIG. 15 is a block diagram showing a configuration of a control device 2 according to a modification of the embodiment of the present disclosure. The present modification differs from the above-described embodiment in that a path calculation unit 22 calculates a speed command instead of a position command until a specific target stop position is reached, unlike the path calculation unit 12 of the above-described embodiment. That is, the path calculation unit 22 calculates the speed command until the specific target stop position is reached based on the acceleration command of the orientation control. Therefore, in the present modification, unlike the above-described embodiment, the integrator 13 and the position control unit 14 are not provided.

According to the present modification, the same orientation control processing as that of the above-described embodiment is executed, and the same advantageous effects as those of the above-described embodiment are achieved.

In addition, the present disclosure is not limited to the above-described embodiments, and modifications and improvements within a range in which the object of the present disclosure can be achieved are included in the present disclosure.

### EXPLANATION OF REFERENCE NUMERALS

1, 2 control device (motor control device)
3 motor (induction motor)
4 current sensor
5 position and speed sensor
11, 21 acceleration command calculation unit
12, 22 path calculation unit
13 integrator
14 position control unit
15, 25 speed comparison unit
16, 26 speed command calculation unit
17, 27 switching unit
18, 28 speed control unit
19, 29 current control unit

1. A motor control device that controls an induction motor for driving a rotary axis, and executes orientation control for stopping the rotary axis which is rotating at a target position, the motor control device comprising:
a speed comparator that calculates a difference between an actual speed of the rotary axis and a speed command;
a speed command calculator that, in a case in which an absolute value of the difference is smaller than a predetermined threshold, changes the speed command so that the absolute value of the difference is equal to or larger than the threshold;
an acceleration command calculator that calculates an acceleration command for a time of the orientation control, based on an acceleration/deceleration calculated from the actual speed of the rotary axis when the speed command is changed; and
a path calculator that calculates, based on the acceleration command, at least one command of a position command or a speed command until the target position is reached.

2. The motor control device according to claim 1, wherein the actual speed is defined as vₛₜ, the speed command is defined as v₁, and the threshold is defined as vₜₕ, and in a case in which an absolute value of a difference between the actual speed vₛₜ and the speed command v₁ is smaller than the threshold vₜₕ, the speed command calculator changes the speed command v₁ to a speed command v₂₁ expressed by Expression (1) below or a speed command v₂₂ expressed by Expression (2) below,
$$\begin{matrix}[ Expression 1 ] & \\ {v}_{21} = {v}_{st} - {v}_{th} & EXPRESSION ( 1 )\end{matrix}$$
$${v}_{22} = {v}_{st} + {v}_{th} \qquad EXPRESSION ( 2 )$$

3. The motor control device according to claim 1, wherein
the acceleration command calculator calculates an acceleration/deceleration when an applicable maximum electrical current is applied to the induction motor to accelerate and decelerate the induction motor, and sets a value of a maximum acceleration/deceleration having a largest magnitude among calculated accelerations/decelerations as an absolute value of the acceleration command, and
the path calculator calculates a position command for performing acceleration/deceleration at the maximum acceleration/deceleration so as to minimize a time until the target position is reached.

4. The motor control device according to claim 3, wherein the path calculator calculates a position command for accelerating with a maximum acceleration, and then decelerating with a maximum deceleration to stop at the target position.

5. The motor control device according to claim 2, wherein
the acceleration command calculator calculates an acceleration/deceleration when an applicable maximum electrical current is applied to the induction motor to accelerate and decelerate the induction motor, and sets a value of a maximum acceleration/deceleration having a largest magnitude among calculated accelerations/decelerations as an absolute value of the acceleration command, and
the path calculator calculates a position command for performing acceleration/deceleration at the maximum acceleration/deceleration so as to minimize a time until the target position is reached.

6. The motor control device according to claim 5, wherein the path calculator calculates a position command for accelerating with a maximum acceleration, and then decelerating with a maximum deceleration to stop at the target position.
